(19) United States
(12) Patent Application Publication
(10) Pub. No.: US 2016/0119574 A1
(43) Pub. Date: Apr. 28, 2016

(54) SYSTEMS AND APPARATUS FOR AUTOMATED RECORDING AND DISTRIBUTION OF PERFORMANCE EVENTS

(71) Applicant: PROJECT 639 LLC, Seattle, WA (US)

(72) Inventors: Michelle M. MUNN, Seattle, WA (US); Lloyd A. MOORE, Renton, WA (US)

(21) Appl. No.: 14/925,915

(22) Filed: Oct. 28, 2015

Related U.S. Application Data
(60) Provisional application No. 62/069,768, filed on Oct. 28, 2014.

(51) Int. Cl. H04N 5/77; H04N 5/232; H04N 5/247; H04N 7/18

(52) U.S. Cl. CPC H04N 5/77; H04N 7/181; H04N 5/232; H04N 5/247

(57) ABSTRACT

Disclosed is a multi-camera automated recording of performances system and method.

### BACKGROUND

Presently the effort to record a live performance is both time and labor intensive. Each video camera is controlled by a cameraman; a director then coordinates the camera activity and decides which shots to record to the master program. Following the collection of video footage, additional time may be spent editing the event into a final form before publishing the event to the selected audience.

### SUMMARY OF THE INVENTION

Described is an automated system to capture, manage, and distribute a live event where the subject of interest is an individual or a small group of individuals. By reducing the time and labor necessary to produce a live performance the cost of the performance can be reduced, and the performance can be made available more quickly to a larger audience. Various embodiments seek to reduce the recurring cost of capturing, managing, and distributing live performances.

Described herein are multiple subsystems working in a coordinated and integrated manner to automate the tasks of recording a live performance in a contextually appropriate and aesthetically pleasing way, edit the recording to enhance the aesthetics of the recorded performance and publish the performance for consumption by a selected audience.

The high level organization and interconnection of the various subsystems will described, followed by additional detail as needed for each subsystem.

### BRIEF DESCRIPTION OF THE DRAWINGS

FIG. 1 illustrates a simplified network topology of a system in accordance with various aspects of at least one embodiment.

FIG. 2 illustrates a simplified software control flow of a systems in accordance with various aspects of at least one embodiment.

FIG. 3 illustrates a simplified block diagram of an optical tag suitable for use in accordance with various aspects of the present and systems.

### DETAILED DESCRIPTION

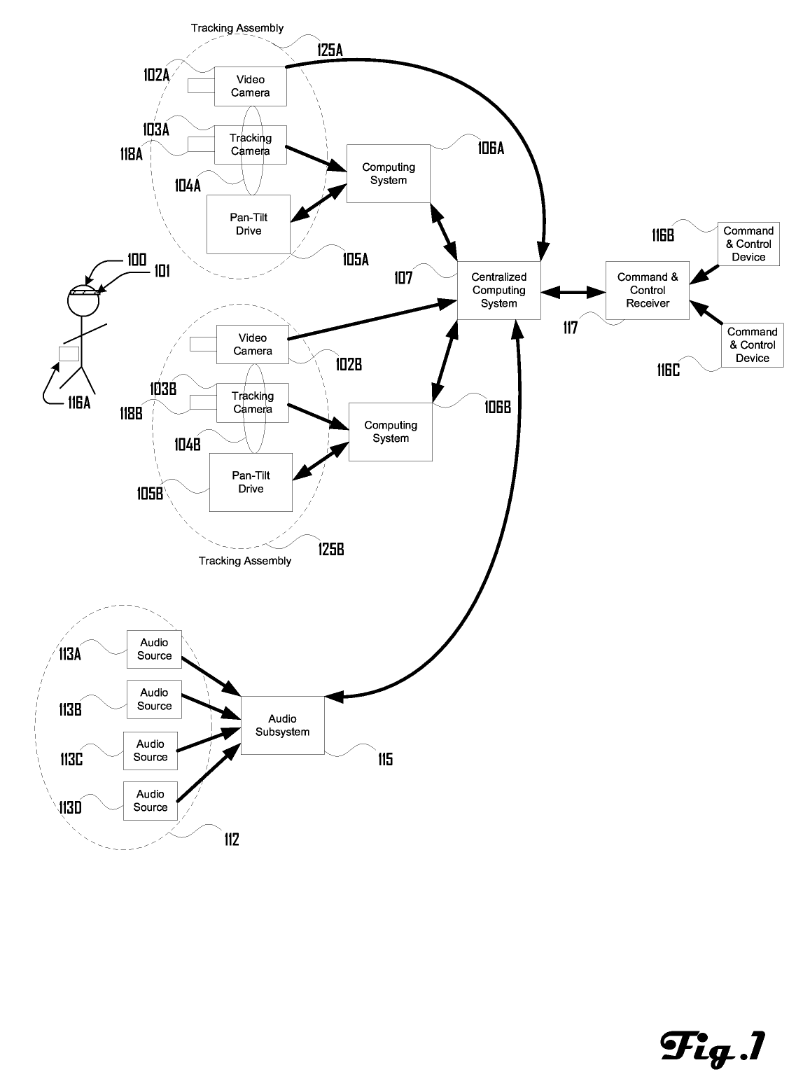

Referring to FIG. 1:

A performer of interest 100 is fitted with an optical tag 101. The optical tag is uniquely identifiable in the visual field by one or more tracking cameras 103 (shown as 103A and 103B in FIG. 1).

Optical tag 101 serves to identify person(s) of interest in the performance. An example optical tag 101 uses a narrow band light emission so that it is easily separable from visible light objects, however future versions may be any form of electromagnetic, acoustic, or particle emission. Optical tag 101 may also be constructed as a purely passive device or optionally illuminated from an external source. An example of an optical tag 101 places the optical tag 101 on the head of the person of interest 100; however other placements may also be desirable. Multiple optical tags 101 may also be placed on a single performer of interest 100 to further define points of interest (not shown) on the person of interest 100. An example of these placements may, but not be limited to: the wrist, neck, waist, ankles or any combination thereof.

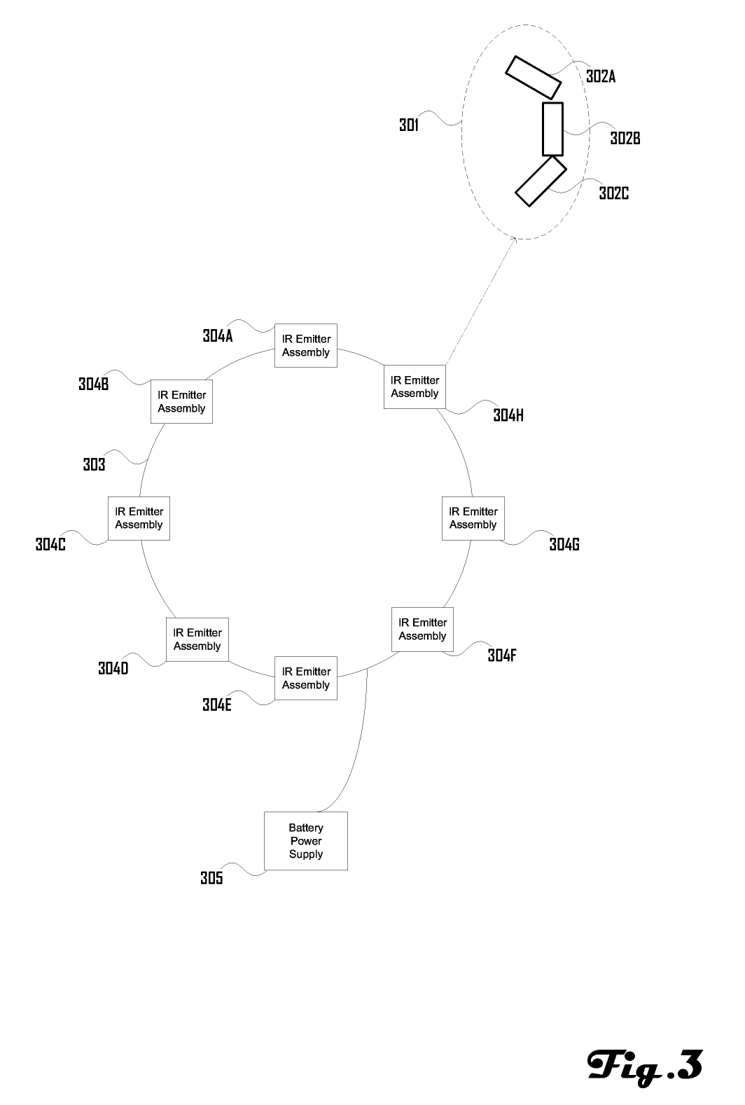

Optical tag 101 may be a headband worn by the performer of interest 100. If performer of interest 100 is already wearing a headband of some type optical tag 101 may be designed in such a way to be physically combined. Additionally optical tag 101 may be combined with any other form of headgear (not shown), or body adornments (not shown) worn by performer of interest 100. FIG. 3 describes one example of Optical Tag 101 in more detail.

Referring to FIG. 3:

Optical tag 101 includes of a plurality of narrow band NIR emitters operating at 940 nm, in one example.

A plurality of emitters 302A, 302B, 302C are clustered together such that the angular emission pattern of the cluster is at least 180 degrees in what will typically be the vertical direction. This forms bud 301. A plurality of emitter clusters are then spaced around the headband 303, or similar structure so as to provide a 360 degree emission pattern in what will typically be the horizontal direction of optical tag 101, shown as 304A-304H in FIG. 3. An example of powering buds 301 uses a commercial off the shelf, rechargeable battery pack with integrated voltage regulation Battery Power Supply 305. Additional examples of optical tags 101 may separate buds 301 into any arrangement on, and around performer of interest 100. An example headpiece may be in the form of a ring, a headband of the like.

Referring to FIG. 1:

One or more camera assemblies 125, comprised of a tracking camera 103, a video camera 102, and a pan-tilt drive 105 are deployed such that there is a line of sight to the performer of interest 100 during the performance. The tracking camera 103, video camera 102 and pan-tilt drive are mechanically coupled in a mount 104 such that the cameras 102 and 103 are held in a fixed alignment with respect to each other and can be moved by pan-tilt drive 105.

One example of tracking camera 103 is a commercial off the shelf NIR machine vision camera, such as, but not limited to UEye model UI-1240LE-NIR-GL. Tracking camera 103 is fitted with a commercial off the shelf CCTV lens 118. One suitable example of the camera lens 118 is a lens with an F Stop rating of f2.1 or better, variable focus and aperture settings. Tracking camera 103 is also fitted with a NIR bandpass filter centered at 940 nm, and a pass band of +−5 nm, such that only light from optical tag 101 is detected by tracking camera 103. Additional examples of lens 118 may include, but not be limited to fixed focus lenses, fixed aperture lenses, lenses with optical elements which provide preferential transmission of energies or particles emitted by optical tag 101 and any combination of previously mentioned attributes.

One example of video camera 102 and pan tilt drive 105 is a commercial off the shelf video conferencing camera assembly Sony EVI HD1. Tracking assembly 125 has been modified to allow for mechanical coupling of tracking camera 103 to video camera 102 in a rigid manner.

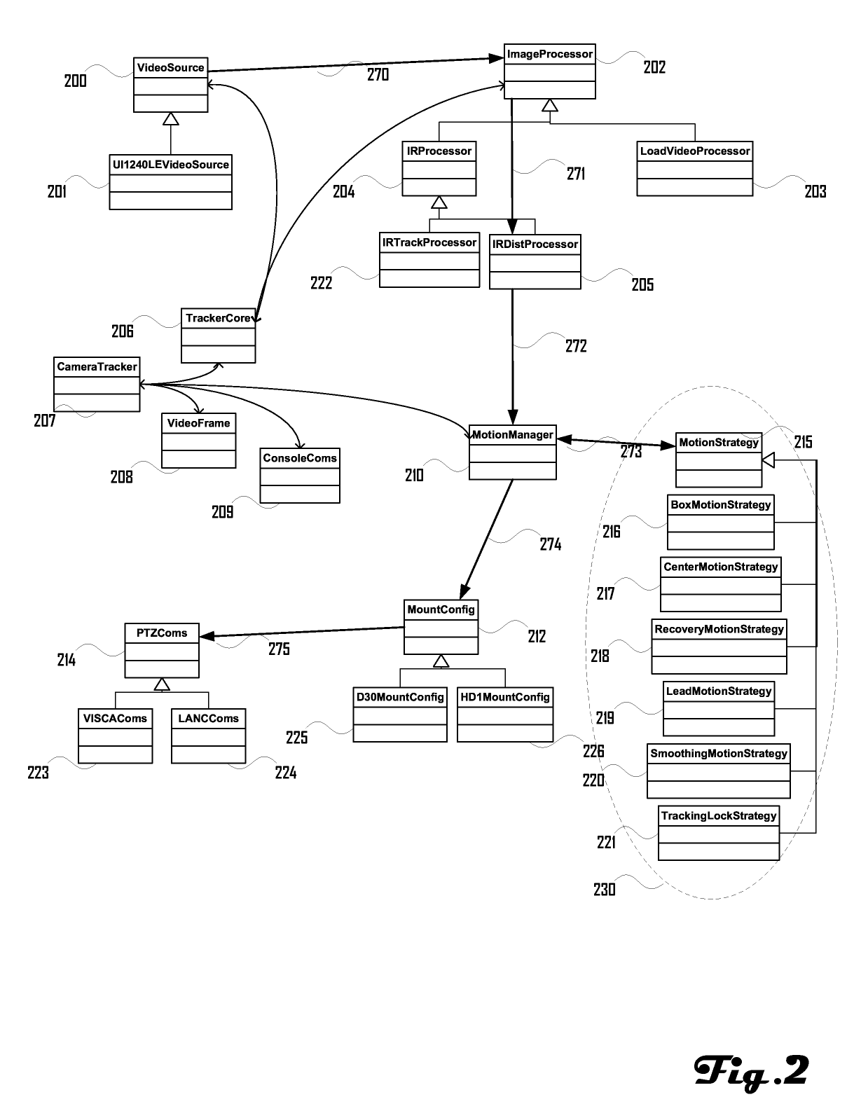

Computing system 106 receives video input from tracking camera 103. Computing system 106 runs software, outlined in FIG. 2, able to process the video image of optical tag 101 and issue commands to pan-tilt drive 105 in such a manner as to hold optical tag 101 within a predefined portion of the field of view of tracking camera 103.

One or more tracking assemblies 125 may be deployed in an arbitrary arrangement, with the goal that one or more tracking assemblies 125 has line of sight to the optical tag 101 throughout the performance.

Video camera 102 from each tracking assembly 125 is attached to a centralized computing system 107. Computing system 106 from each tracking assembly is connected to centralized computing system 107 with a bi-directional communications link. The centralized computing system 107 is also contains data storage device.

Centralized computing system 107 is connected to audio subsystem 115 with either a unidirectional or bidirectional link. In the case of a bidirectional link centralized computing system 107 can effect changes on each audio channel of audio subsystem 115. Alternatively multiple unidirectional links may be provided, with one audio channel over each link allowing centralized computing system 107 to affect changes locally to each audio channel.

Audio subsystem 115 is connected to a plurality of audio sources 112, examples of audios sources may be, but not limited to: microphones 114, some of which may be wireless microphones 114, and a plurality of arbitrary audio sources 113, such as line outs from common audio equipment. Example audio sources include, but not limited to, a music track and ambient sound from the recording environment 400.

A plurality of optional command and control devices 116 may be present. In one example a command and control device 116 may be a remote control, in another example it may be a joystick. Command and control devices 116 send signals to command and control receiver 117, which is connected to centralized computing system 107. Command and control devices 116 may be wired or wireless. Performer of interest 100 may affect the operation of the overall system using one or more command and control devices 116.

Command and control devices 116 allow for interaction between the performer of interest 100 and the centralized computing system 117, with the intent of allowing performer of interest 100 to influence the overall system operation with the purpose of, but not limited to, setting specific operational modes, providing hints as to upcoming events of interest within the performance that inform recording decisions, stylizing and/or enhancing aesthetic properties of the recorded performance. Examples of command and control devices 116 are, but not limited to: commercial off the shelf radio frequency (RF) controllers, RF key fobs, home entertainment remote controls, gaming controllers as well as repackaged versions of the above and the like.

Optionally command and control devices 116 may eliminate a physical apparatus and may use machine processing of any video or audio stream to search for predefined signals and gestures to trigger any operation anywhere in the system which can be signaled using the existing command and control device 116. Triggered changes may happen, for example, on the computing system 106, centralized computing system 107, any camera, any attached system device, but not be limited to these options.

Command and control devices 116 signal, performance start and stop, performance pause and resume, camera lock, camera preference, predetermined zoom settings, zoom adjustments, environmental effects, commands to the audio subsystem, commands to the centralized computing system 107, and annotations stored within the centralized computer system by messaging over existing system links. One example is a smartphone app consisting of control settings specific to a performer of interest 100, including but not limited to zoom levels, height, vertical and horizontal bias settings, audio gain levels etcetera.

Centralized computing system 107 runs commercial off the shelf software for the simultaneous recording of all video and audio streams stored to the centralized computer system 107. An example of this software is LiveStream Studio 500 software. Centralized computing system 107 is able to select a particular video stream, in real time, to record as an additional channel stored within the centralized computer system 107. Centralized computing system 107 is also able to affect changes to the audio streams, in real time, and record a selected combination of audio channels as an additional channel stored within the centralized computer system 107.

Centralized computing system 107 also runs software, to be implemented in a future version, effecting the autonomous control of any and all system components such as, but not limited to: video camera 102, tracking camera 103, pan-tilt drive 105, computing system 106, command and control receiver 117, internet server and storage device 109 and audio subsystem 115.

Each computing system 106 contains software as outlined in FIG. 2, henceforth described in detail.

Referring to FIG. 2:

Input from each tracking camera 103 is received into a generalized video source object 200. Video source object 200 forms a base class representing a generic camera in the program supporting common camera operations such as, but not limited to: opening the camera, closing the camera, querying camera settings, modification of camera settings, starting video capture, notification of new frame arrival, and querying camera status. Specific makes and models of cameras are supported by specializing the object, shown as UI 1240 LE video source object 201 for the Ueye UI-1240LE-NIR-GL. Video source 200 and UI 1240 LE video source 201 are related in the traditional “is a” inheritance relationship. Additional derivations of video source 200 may also be included to support additional camera types.

Received video image is passed to general image processor object 202 as shown by data flow 270. Image processor 202 forms a base class representing a generic image processor in the program supporting operations such as, but not limited to: image buffer allocations, performing an operation on the video buffer, and graphical annotations of the video buffer.

Image processor object 202 is specialized as IR processor object 204, for example, and may be further specialized as IRDistProcessor 205. IRDistProcessor object 205 receives the image from ImageProcessor 202 over dataflow 271, and searches the given image for bright spots which may represent the current location of optical tag 101 in the field of view. Bright spots are saved as a collection. For example IR processor object 205 will first binarize the received object using a predetermined, and possibly adaptable thresholding algorithm. The binarized image can then be subjected to a conventional blob analysis to determine objects of interest in the given frame. The collection of bright spots is then subjected to further processing, by IR Dist Processor 205, in this particular example, to filter for size, shape, circularity, or any other attribute presented by a particular image.

Various embodiments may choose to add additional derivations of image processor 202. The derivations may be specialized so as to be maximally sensitive to certain attributes or properties of a given bright spot, thereby removing false images of the optical tag 101. The location of the optical tag in the field of view is then passed to the motion manager 210 via data flow 272.

Additional image processor derivations are also possible, such as LoadVideoProcessor 203 which simply replaces the captured image with an image from local disk storage, as has been determined to be beneficial for various debugging scenarios. IRTrackProcessor 222 is another possible derivation representing a simpler machine vision algorithm to achieve similar objectives to IRDistProcessor 205. An unbounded number of combinations and permutations are possible with various combinations of image processing objects and algorithms to achieve needed processing steps.

Motion manager 210 passes the optical tag position to a collection of motion strategy objects 230 via dataflow 273, and receives commands back via the same data flow. Each motion strategy object inspects the current optical tag position and the current state of the system and optionally recommends a pan-tilt command, based on the specifics of the motion strategy, and optionally pan-tilt commands recommended to date. Once all strategies have inspected the current system state a single pan-tilt command remains. The operations of the various members of the Motion Strategy 215 hierarchy will be described henceforth.

Box motion strategy 216 is responsible for keeping the image of optical tag 101 inside a user defined box within the field of view. If the X coordinate of optical tag 101 exceeds the lower X coordinate of the bounding box, Box motion strategy 216 will issue a pan tilt command such as to increase the value of the X coordinate via motion of pan-tilt drive 105. If the X coordinate of optical tag 101 exceeds the upper X coordinate of the bounding box, Box motion strategy 216 will issue a pan tilt command such as to decrease the value of the X coordinate via motion of the pan-tilt drive 105. A similar analysis is completed for the Y coordinate and direction.

Center motion strategy 217 works in a similar manner to that of box motion strategy 216 where the coordinate of optical tag 101 is replaced by a time averaged value of the coordinate, and a separate user defined box is used. Various averaging techniques may be used here including but not limited to: simple averaging, streaming averaging, time weighted averaging, profile weighted averaging, median, mode, and no averaging.

Recovery motion strategy 218 detects when optical tag 101 has left the field of view of tracking camera 103, and may, in some examples maintain a history of coordinates for optical tag 101 when it was visible. Once optical tag 101 leaves the field of view recovery motion strategy 218 enters a state machine in an attempt to reposition optical tag 101 into the field of view. The state machine will detect various conditions including but not limited to: blinking of optical tag 101, motion of optical tag 101 from the field of view in a particular direction, arbitrary seek patterns, inspection of preferential camera positions, and arbitrary fixed and variable delays. Recovery motion strategy 218 may combine various recovery techniques to a chain of recovery techniques in an attempt to restore optical tag 101 to the field of view. The combination of particular state changes may additionally result in emergent behaviors and results which are not explicitly coded, and may appear adaptable in certain contexts.

Lead motion strategy 219 attempts to compensate for continuous unidirectional motion by temporarily modifying the bounding box used by other motion strategies in the motion strategy collection 230. Motion may be compensated for in either the X, Y, or X and Y directions. Lead motion strategy 219 monitors position of optical tag 101 in the field of view, and with respect to the edge of the field of view, along with a user defined box. Similar to the methods used by box motion strategy 216, when the X coordinate of optical tag 101 is within the predefined border frame, as defined by the boundary of the field of view and box the lead motion strategy 219 will modify a user defined bounding box of another motion strategy causing the strategy to effect an output value earlier than it would normally be.

Smoothing motion strategy 220 monitors the effective outputs of other members of motion strategy collection 230 and applies a predetermined averaging function to the resulting motion commands of the strategies. The effect of smoothing motion strategy 220 is to blend, and smooth the actions of prior strategies so as to simulate fluid movement. Various implementations of smoothing motion strategy 220 may use, but not be limited to: simple numeric averages, time weighted averages, median averages, modal averages, temporal weighted averages, profile weighted averages, streaming averages, and/or discontinuous averaging techniques.

Tracking lock strategy 221 monitors motion of the optical tag 101. If optical tag 101 does not move for a predetermined time tracking lock strategy 221 will initiate specific commands to pan-tilt drive 105 to explicitly move optical tag 101 out of the field of view of tracking camera 103. The predetermined command may be any command acceptable to the pan tilt drive in use.

Motion strategy collection 230 form a hierarchy of objects which may be combined in various ways to produce various effects on camera tracking. The strategies outlined prior are simply examples of one particular embodiment. Other examples may include additional strategies or eliminate strategies. The strategies also interact to produce emergent behaviors which are not explicitly programmed into any one particular strategy. Strategies may, but are not required to combine in other ways such as, but not limited to: voting, subsumption, domination, averaging, state machine flows, parameter modification, and code modification.

Motion manager 210 interprets the resulting computation of motion strategy collection 230 context of the current pan-tilt drive 105 as defined by general mount config object 212 and specifically selected mount configuration object 225 or 226 in the present example. The object used is selected at by the programmer when the system is configured. Mount config 212 forms a base class of pan-tilt mount configurations. Mount config 212 is then specialized for each mount to be used in the system such as D30 Mount Config 225, for the Sony D30 camera; and HD1 Mount Config 226, for the Sony HD1 camera, using a standard inheritance mechanism. Each mount config instance contains and represents various mount parameters such as but not limited to: movement velocities, movement bounds, command formats and communications protocols. The resulting command is passed to generalized PTZ communication object 214 via data flow 275. Generalized PTZ communication object 214 then delegates to a specific PTZ communication object 214, such as but not limited to 223 or 224 passing the selected PTZ command to the physical mount, resulting in movement of tracking assembly 125.

PTZ Coms 214 represents a base class of various communications protocols. PTZ Coms 214 may be specialized through common inheritance mechanisms to represent specific communications protocols such as VISCA in the case of VISCA Coms 223 and LANC Coms 224. Protocols may be added or eliminated for a particular embodiment as needed by the embodiment.

General coordination of tracking operation is controlled by Tracker Core object 206. Tracker Core object 206 is also responsible for the instantiation and lifetime management of Motion Manager 210, Image Processor(s) 202:205, and Video Source(s) 200:201.

Coordination between computing system 106 and the rest of the system is managed by camera tracker object 207 and console communication object 209. Camera tracker object 207 is responsible for instantiation and management of the general software running on computing system 106. Camera tracker software 207 has a video frame 208 for local diagnostic display. Command, control and status messages being passed between computing system 106 and the rest of the system is managed by console communications object 209.

Although specific embodiments have been illustrated and described herein, a whole variety of alternate and/or equivalent implementations may be substituted for the specific embodiments shown and described without departing from the scope of the present disclosure. This application is intended to cover any adaptations or variations of the embodiments discussed herein.

1. A multi-camera automated performance recording system and method as shown and described.
